(19) United States
(12) Patent Application Publication
(10) Pub. No.: US 2002/0087831 A1
(43) Pub. Date: Jul. 4, 2002

(54) Instruction packetization based on rename capacity

(76) Inventors: Nicholas G. Samra, Austin, TX (US); Bradley G. Burgess, Austin, TX (US)

Correspondence Address: KENYON & KENYON, 333 W. San Carlos, Street, Suite 600, San Jose, CA, 95110-2711, US

(21) Appl. No.: 09/752,573

(22) Filed: Dec. 28, 2000

(51) Int. Cl. G06F 9/30

(52) U.S. Cl. 712/205; 712/214

(57) ABSTRACT

An apparatus and method for loading instructions into a trace cache line using instruction packetization to increase the throughput of instructions through a given rename unit. The present invention uses the properties of the particular sequence of instructions to eliminate the redundant allocation of source and destination registers which may increase the number of instructions that can be processed simultaneously without increasing the size or complexity of the rename unit.

### FIELD OF THE INVENTION

The present invention relates to computer architecture. More particularly, the present invention relates to increasing the number of instructions that may be processed by examining the utilization of renaming resources on a per-packet basis.

### BACKGROUND OF THE INVENTION

Superscaler microprocessors process multiple instructions simultaneously. For a given clock speed, higher instruction throughput will generally be somewhat correlated to the superscale degree, or the number of instructions that can be processed simultaneously, which is commonly known as the “width” of the processor. With everything else being equal, microprocessor architectures providing a higher width provide higher performance.

A difficulty with using the single metric, width, is that it may vary different processing stages. One point typically used to measure width is at the boundary between in-order (un-renamed) and out-of-order (renamed) instructions, which is usually at the rename stage of the processor pipeline.

One way to increase the width of the in-order and out-of-order instruction boundary is to increase the size of the rename unit. This option, however, requires incurring additional hardware costs, allocating a greater chip area for renaming, etc. Instead it would be desirable to increase the number of instructions that may be processed at the rename stage without changing the design or size of the rename unit.

Those of ordinary skill in the art are generally familiar with the techniques and reasons for executing some instructions out-of-order, and with the use of rename units in superscaler microprocessors. This general familiarity with rename units will be assumed by the present disclosure. While the present invention is likely to be used in conjunction with rename units, the present invention is not intended to be limited to use with any particular design, or size, rename unit.

As will be explained more fully below, prior art microprocessors typically take the size of the rename unit as a design constraint, and load instructions into a trace cache line with a size that will always be completely utilized. It would be desirable to take advantage of the characteristics of the mix of actual instructions, and when feasible to load more instructions into the trace cache line than would be attempted by prior art designs. Such an approach would allow a greater width of instructions to flow through the rename stage, in many instances, than would be possible if the trace cache line size is limited to the worst case situation for a particular rename unit.

### BRIEF DESCRIPTION OF THE DRAWINGS

FIG. 1 is a block diagram illustrating the flow of instructions through a rename unit using a trace cache line.

FIG. 2 illustrates the packetization of a stream of instructions into a trace cache line in accordance with an embodiment of the present invention.

FIG. 3 is a block diagram illustrating the flow of instructions through a rename unit using a trace cache line in accordance with an embodiment of the present invention.

### DETAILED DESCRIPTION

The present invention examines a string of instructions to determine the actual system resources required by the string, and loads the instructions into a trace cache line based on the resource requirements. Embodiments of the present invention may allow use of larger trace cache line sizes than might be otherwise used with a given rename unit. Instead of sizing the trace cache line so that it will always be fully loaded, embodiments of the present invention use instruction packetization to allow greater use of rename unit capacity than without such packetization.

Rename units are commonly used in superscaler microprocessor architectures to rearrange the processing of individual instructions in order to achieve increased instruction-level parallelism. The use of rename units is known to those or ordinary skill in the art. The rename unit performs essentially three functions. First, reading and writing to a register alias table (RAT), which maps logical registers to physical registers. Second, the allocation of additional registers to sequences of instructions. Third, the rename unit processes the logical inter-instruction dependencies, such as when the result of one instruction is needed as input by another instruction. For the purpose of this present disclosure, a particular rename unit can be thought of as having a given capacity, where capacity consists of the number of sources (or reads) and the number of destinations (or writes) that the rename unit is capable of processing in a single step. For example, one rename unit may have the capacity for processing eight sources and four destinations while another has the capacity for processing four sources and four destinations. Of course, all else being equal, a larger capacity rename unit is better than a smaller one. But all else is typically not equal, and designers must limit the rapidly increasing complexity, and cost, of higher rename capacity. Similarly, the ratio of sources and destinations is typically the result of design decisions that attempt to carefully balance various costs and benefits. For purposes of the present invention, a particular rename unit's capacity, in terms of the maximum number of source and destination registers, is given. The present invention takes this rename capacity, whatever it might be, and uses an instruction packetization technique to more fully utilize that capacity.

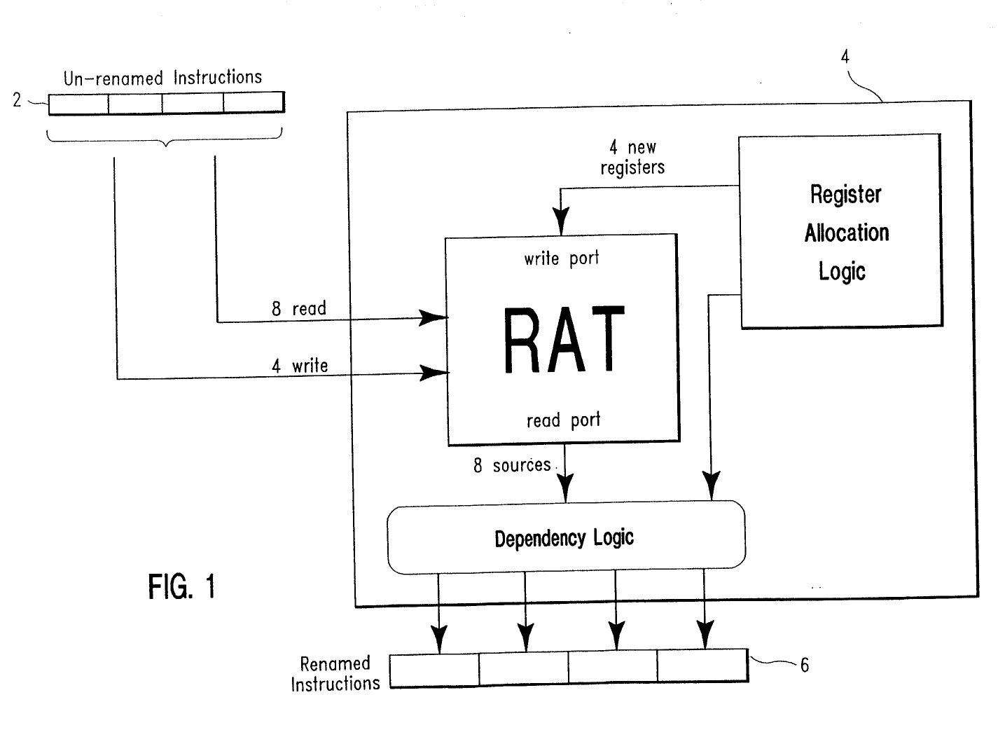

FIG. 1 is a block diagram illustrating a sequence of un-renamed instructions 2 interacting with a rename unit 4 to create a sequence of renamed instructions 6. In this example un-renamed instructions 2 are stored in a trace cache line of size 4. That is, four instructions are stored in each sequence of instructions. The prior art approach to the processes shown in FIG. 1 is to size instruction sequences 2 and 6, and trace caches, so that each is full, and rename unit 4 is always capable of processing these full trace cache lines. For the example in FIG. 1, a sequence of four un-renamed instructions 2 are processed in to a sequence of four renamed instructions 6 by rename unit 4, which has a capacity of eight source and four destinations.

The above sizes and capacity for trace lines 2 and 6, and rename unit 4 are based on a worst case scenario of each instruction having two independent sources and one independent destination. However, not every instruction actually conforms to the worst case, and sequences of instructions often share source and/or destination registers. Embodiments of the present invention exploit these properties to increase the maximum trace cache line size for a given rename unit.

Typical assembly language categories of instructions include arithmetic, or logical, operations, such as ADD r2, r3, r4 and MUL r2, r3, r4, date transfer operations, such as LOAD r2, [r3], and central operations such as BRANCH, and perhaps others. Most instruction sequences will contain a mix of instructions from different categories. One consequence of a mix of instructions is that not every instruction uses the same number of operands. In the above examples, registers r3 and r4 were the sources for instructions ADD and MUL, with register r2 the resulting destination, while the BRANCH instruction did not use any source or destination. In this admittedly limited set of instructions, a rename capacity of two sources and one destination per instructions would be sufficient for any instruction, although that capacity might not be fully utilized for a particular instruction sequence.

At a more general level, the format of an instruction may be given by:

Instruction Type Dest₁ . . . Destₙ Source1 . . . Sourceₘ

where Instruction Type specifies the particular instruction, or Opcode, and Destₙ and Sourceₘ represent the possible destinations, or other instruction parameters. The worst case, in terms of the rename unit capacity needed for each of these generalized instructions could be m sources and n destinations. At the other extreme, the instruction might not require any sources and/or destinations. Therefore, a fixed size trace cache line size of x instructions could require a rename unit with a capacity of anywhere from zero to xm sources and xn destinations. Using an instruction set with a limited number of operands, such as mₘₐₓ=2 and nₘₐₓ=1, limits but does not eliminate, the variation in the rename unit capacity required for a given fixed size trace cache line size. Similarly, the use of very small trace cache lines limits the variation.

Rather than designing a microprocessor architecture to minimize the variation in the required rename capacity, there are benefits in allowing both instruction sets with a wide variation in the allowed number of operands and large trace cache line sizes. Allowing complex instruction formats permits, for example, the “packing” of several related operations into a single word. As word sizes increase, along with bus capacity, it may be advantageous to pack multiple, relatively simple, instructions into a single instruction that has many operands.

Permitting large trace cache lines is desirable in a superscaler microprocessor, as is evident from the use of the trace cache line size as a measure of the width of the microprocessor.

The examples given in this present disclosure are based on an instruction set architecture with a maximum of two sources and one destination. These limits are used in the examples so that embodiments of the present invention can be clearly conveyed, and the present invention is not intended to be restricted to use with any system with any such limits on the instruction set architecture.

Prior art microprocessors often use the capacity of the rename unit to define the size of the trace cache line size. This design approach ensures that every instruction in the trace cache can be renamed in a single rename cycle, but may under-utilize the capacity of the rename unit in some instances. The present invention, instead, allows for a larger number of instructions in the trace cache line when, because of the nature of the particular set of instructions, there is capacity within the rename unit to process all the instructions within a given cycle. Embodiments of the present invention allow use finite size trace cache lines, but there may be instances where the trace cache line contains only the number of instructions within the capacity of the rename unit, and with some capacity unused. That is, increasing the maximum trace cache line size and filling the trace cache line with instructions based on the capacity of the rename unit, the present invention may better utilize the capacity of the rename unit, and increase the width of the processor, without incurring the costs and complexity of a larger rename unit.

Rename unit 4 in FIG. 1 has the capacity of renaming instructions with up to eight sources and four destinations. Prior art microprocessors would often use the worst case situation of two sources and one destination per instruction to set the number of unrenamed instructions 2, and renamed instructions 6, in the trace cache to four. With such a design, rename unit 4 is always able to process all the instructions in a single cycle. However, such prior art designs do not examine the actual mix of instructions being renamed and may miss the opportunity to fully utilize the capacity of rename unit 4.

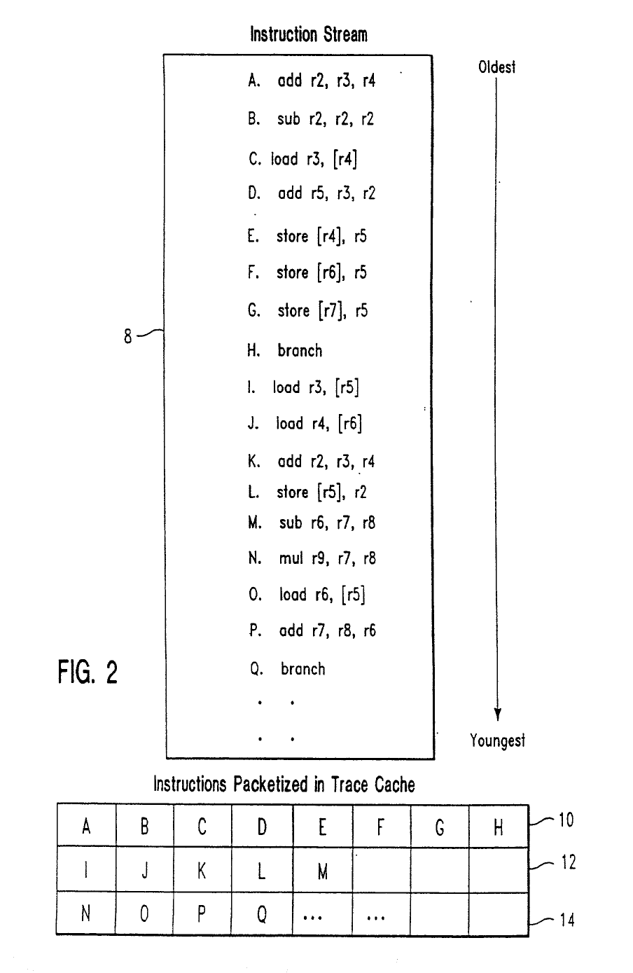

FIG. 2 illustrates how an embodiment of the present invention uses “packetization” of instructions to achieve a greater width using rename unit 4, with its capacity of eight sources and four destinations, by more closely examining the actual instructions going into the trace cache line. Instruction stream 8 contains seventeen instructions, labeled “A” through “Q”, that will be placed in trace cache lines 10, 12 and 14, and eventually executed by the microprocessor. A trace cache line maximum size of eight instructions is used in FIG. 2 for trace cache lines 10, 12 and 14. This eight-instruction cache line size is double the size as was used in FIG. 1.

The packetization technique of the present invention examines each instruction in stream and may exploit up to three potential avenues for loading more instructions into a trace cache line than allowed by the worst case for rename unit 4. First, not every instruction will impose the worst case combination of sources and destinations on rename unit 4, which is two sources and one destination here. The first instruction, ADD r2, r3, r4, uses two sources and one destination, STORE [r4], r5, uses two sources and no destinations, and BRANCH uses no sources or designations.

Second, not all destinations need to exist outside of the packet of instructions within a single trace cache line. For example, if a packet contains the instruction ADD r3, r4, r5 followed by SUB r3, r3, r6, the ADD instruction destination, r3, is only needed the subsequent SUB instruction, and does not need to be written into the RAT.

Third, multiple instructions within a single trace cache line may access the same source register for data. When this occurs, only one read at the RAT is needed to generate the rename for each of several sources in the packet.

In FIG. 2, the first eight instruction, A through H, require a total of five sources (r2, r3, r4, r6, and r7) and three destinations, (r2, r3, and r5). Note that register r5 is produced by instruction D and is then used by instructions E, F, and G. From the frame of reference for the entire packetized trace cache line 10, register r5 is not a source, although it is a destination.

Trace cache line 10 is thus able to hold eight instructions and it has not used all the capacity of rename unit A. For instruction stream 8, a trace cache line size larger than eight could be used without overloading rename unit 4, however a design decision was to limit the trace cache line sizes to eight. Other embodiments of the present invention may use limitations on trace cache line sizes other than eight.

Trace cache line 12 begins with instruction I and contains five instructions. This trace cache line uses four destination registers (r3, r4, r2, and r6) and reaches the maximum capacity of rename unit 4 before entirely filling trace cache line 12. Note, however, that trace cache line 12 with five instructions, exceeds those of prior art trace cache lines 2 and 6 shown in FIG. 1, although it is not full.

The remaining instructions, in instruction stream 8, N through Q, are placed in trace cache line 14. Line 14 then has three destinations and may be able to accommodate additional instructions.

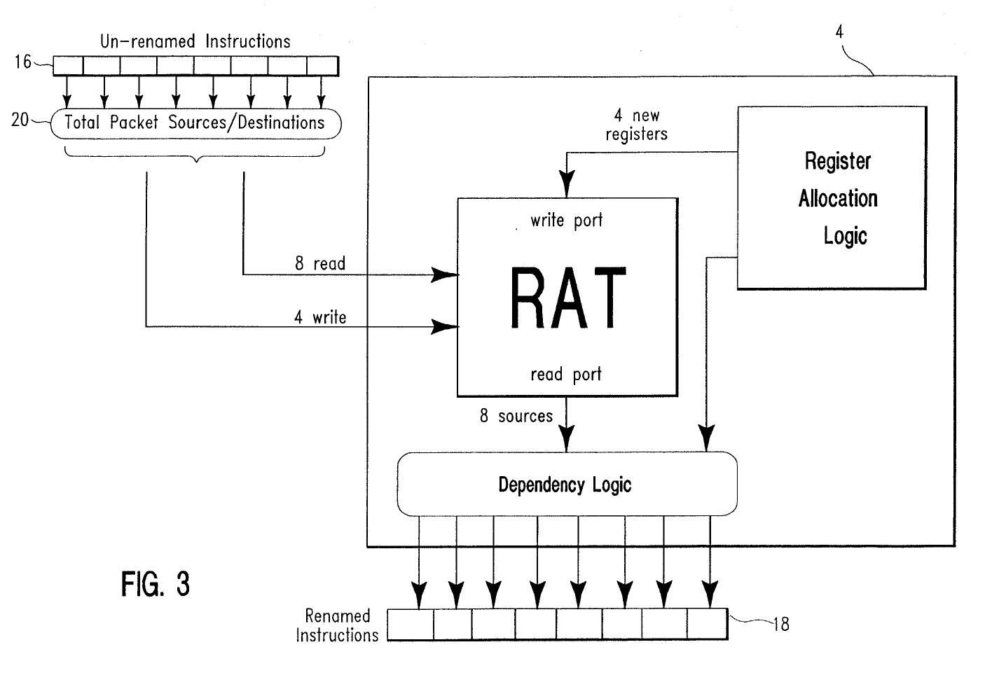

FIG. 3 is a block diagram of an embodiment of the present invention somewhat similar to FIG. 1. Packetization logic 20 is shown logically coupled to un-renamed instructions 16 to evaluate the sources and destination of the entire packet prior to submission to rename unit 4. The placement of packetization logic 20 “downstream” from un-renamed instructions 16 may be reversed in other embodiments of the present invention where the packetization logic is implemented by parsing a large sequence of un-renamed instructions, using packetization, to create a trace cache line of un-renamed instructions. The present invention is not intended to be limited to any particular order of placing un-renamed instructions 16 into a trace cache line. Unlike FIG. 1, the trace caches for un-renamed instruction 18 now exceeds the size of what a worst case sequence of instructions could impose on rename unit 4. However, with the above packetization technique, the trace cache lines may not be full during end rename cycle.

The present invention might be thought of as using the concept of packet granularity for placing instruction in a trace line, similar to the way the rename unit operates at a packet granularity level. Thus, the size of the trace cache lines, the input and output to the rename unit, is more closely correlated to how a rename unit operates than prior art designs, which used trace cache line sizes matched to a worst case processing situation. In this way, redundant sources with a packet need only RAT access for the packet, instead of one RAT access per instruction. Similarly, some destination RAT accesses can be eliminated. Eliminating unnecessary RAT access has the added benefit of reducing the power requirements for the microprocessor as well as increasing the width.

The present invention may be implemented in hardware, software, firmware, as well as in programmable gate array devices, ASICs and other similar devices.

While embodiments and applications of this invention have been shown and described, it would be apparent to those skilled in the art, after a review of this disclosure, that many more modifications than mentioned above are possible without departing from the inventive concepts herein. The invention, therefore, is not to be restricted except in the spirit of the appended claims.

What is claimed is:

1. A method for processing instructions in a superscaler microprocessor, comprising:
selecting an initial sequence of instructions for inclusion in a trace cache line;
determining a set of rename resources needed for said trace cache line on a per-packet basis;
adding one or more provisional instructions to said trace cache line to create a provisional trace cache line;
repeating said determining step for said provisional trace cache line;
comparing said set of rename resources needed for said provisional trace cache line to a rename capacity; and
accepting said one or more provisional instructions for inclusion in said trace line and repeating said adding step, or rejecting said one or more provisional instructions, based on said comparing step.

2. A method in accordance with claim 1, wherein:
said set of rename resources needed and said rename capacity include a source parameter.

3. A method in accordance with claim 1, wherein:
said set of rename resources needed and said rename capacity include a destination parameter.

4. A method in accordance with claim 1, wherein:
said set of rename resources needed and said rename capacity include a line size parameter.

5. A method in accordance with claim 1, wherein:
determining a set of rename resources needed on a per-packet basis excludes destinations subsequently over-written within the packet from said set of rename resources needed.

6. A method in accordance with claim 1, wherein:
determining a set of rename resources needed on a per-packet basis excludes redundant sources within the packet from said set of rename resources needed.

7. A method in accordance with claim 1, wherein:
determining a set of rename resources needed on a per-packet basis excludes sources created within said trace cache line.

8. A method in accordance with claim 1, wherein:
selecting said initial sequence of instructions uses a worst case assumption of said set of rename resources needed.

9. A method in accordance with claim 1, wherein:
selecting said initial sequence of instructions includes tabulating a maximum rename resource cumulative total based on a plurality of instruction types.

10. A method in accordance with claim 1, wherein:
selecting a number of provisional instructions is performed based on a difference between said set of rename resources needed and said rename capacity.

11. An apparatus for processing instructions in a superscale microprocessor, comprising:
an instruction stream with a plurality of instructions;
a trace cache line for receiving said instructions from said instructions stream;
a packetized instruction resource calculator for determining a set of rename resources needed for said instructions in said trace cache line;
an instruction adder, responsive to said packetized instruction resource calculator, for adding one or more instructions to said trace cache line from said instruction stream while said set of rename resources needed is less than a rename resource capacity.

12. An apparatus in accordance with claim 11, wherein:
said set of rename resources needed includes a source parameter.

13. An apparatus in accordance with claim 11, wherein:
said set of rename resources needed included a destination parameter.

14. An apparatus in accordance with claim 11, wherein:
said set of rename resources needed includes a line size parameter.

15. An apparatus in accordance with claim 14, wherein:
said set of rename resources needed includes a source parameter.

16. An apparatus in accordance with claim 15, wherein:
said set of rename resources needed includes a destination parameter.

17. An apparatus in accordance with claim 11, wherein:
said packetized instruction resource calculator excludes destinations subsequently over-written within said trace cache line from said set of resources needed.

18. An apparatus in accordance with claim 17, wherein:
said packetized instruction resource calculator excludes redundant sources with said trace cache line from said set of resources needed.

19. An apparatus in accordance with claim 18, wherein:
said packetized instruction resource calculator excludes sources created within said trace cache line.

20. An apparatus in accordance with claim 11, further comprising:
a trace cache line initializer for initially loading said trace cache lien with an initial number of instructions.

21. An apparatus in accordance with claim 20, wherein:
said initial number of instructions is calculated as a fraction of said rename resource capacity.

22. A method of creating cache lines of instructions in a computer system, comprising:
determining the number of instructions in the cache lines using a packetization of instructions technique and a dynamic cache line size;
matching said dynamic cache line size to a rename unit capacity.

23. A method in accordance with claim 22, wherein:
matching said dynamic cache line size includes eliminating redundant register references within the cache lines.
